(19) United States
(12) Patent Application Publication
(10) Pub. No.: US 2006/0294071 A1
(43) Pub. Date: Dec. 28, 2006

(54) Facet extraction and user feedback for ranking improvement and personalization

(75) Inventors: Christopher B. Weare, Bellevue, WA (US); Stephen M. Ciccarelli, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/168,582

(22) Filed: Jun. 28, 2005

(51) Int. Cl. G06F 17/30

(52) U.S. Cl. 707/3

(57) ABSTRACT

A method includes determining a facet from a web page to be indexed for searching, indexing the web page with the facet in a search index, augmenting a user's web search query with the facet, searching the search index for the facet-augmented query, and presenting to the user, as a search result, the web page based on a correlation of the query and the facet. Another method includes receiving a user's web search query, augmenting the query with a facet, and transmitting the augmented query to a search engine. A further method includes agreeing with an advertiser to associate a web page with a facet, and indexing the web page with the facet in a search index.

### TECHNICAL FIELD

This invention relates to the field of search technology.

### BACKGROUND OF THE INVENTION

Existing web search engines such as Google and Yahoo! index web pages based on the words and metatags contained therein. These search engines receive one or more search terms from a user, then return a list of results that most closely matches the term or terms entered. Search engines have become adept at matching strings efficiently using text; documents are retrieved according to whether they contain the words submitted in a query. The user's query passes directly to the search engine and results are displayed without regard to past user behavior.

For instance, assume two users regularly enter the query term “pizza” into the search engine. The first user likes to go out for pizza and consistently selects local pizza restaurants. The second user enjoys cooking and consistently selects recipes for homemade pizza. The existing web search implementations pass the query directly to the search engine without considering past user behavior and likely user intent. This scheme produces identical results for both users instead of populating the result list for the first user with more pizza restaurants and populating the result list for the second user with more recipes.

The existing implementations are often non-optimal because results that are relevant to the user may be buried in an exhaustive list of irrelevant results. In the above example, the first user might have to navigate through a number of irrelevant results (e.g. national pizza chains with no local franchise) before finding a desired restaurant result. The second user might have to navigate through various restaurants before finding a desired recipe result. In the existing web search implementations, neither user's past behavior is used to increase the proportion of relevant results.

Not only do existing search engines frustrate users' attempts to obtain the most relevant results, but they also impede advertisers' ability to reach their intended audience. For example, if there is a national pizza restaurant chain interested in reaching users searching for “pizza”, the advertiser would pay to associate its website with that term. Each time a user entered the query “pizza,” the advertiser's website would appear regardless of whether the user sought a restaurant, a recipe, or something else in the search result. To reach the highest proportion of its intended audience, the advertiser must consider alternative or additional query terms and potential misspellings. In the present example, to achieve the desired results, the advertiser might be required to pay to associate its website with the query terms “restaurant,” “pizza place,” “pie,” “delivery,” “piza,” “pisa,” “pitza,” etc.

As discussed above, the existing scheme is inefficient. An advertiser paying to associate its website with a query term might reach many uninterested users, cluttering their search list with irrelevant results. A user might also enter a permutation or applicable term not foreseen by the advertiser, possibly preventing an interested user from receiving a relevant search result.

What is needed is a more relevant searching technology, capable of tailoring search results to specific users. This technology should also provide a method for advertisers to better target their intended audience.

### SUMMARY

The present invention provides methods of indexing potential search results with facets, augmenting search queries with relevant facets, searching potential results using facets, aggregating data to compile relevant historical facet data, and agreeing with advertisers to provide search results based on facets. The present invention solves the problems associated with standard search functionality by providing more relevant results to users and by providing advertisers an opportunity to get more value for their money.

### BRIEF DESCRIPTION OF THE SEVERAL VIEWS OF THE DRAWINGS

The present invention is described in detail below with reference to the attached drawing figures, which are incorporated by reference herein and wherein:

FIG. 1 is a block diagram of a computing system environment suitable for use in implementing the present invention;

FIG. 2 is a flow diagram of a facet extraction system, according to the embodiments of the present invention;

FIG. 3 is a flowchart illustrating facet extraction and use, according to the embodiments of the present invention;

FIG. 4 is a flowchart illustrating query augmentation, according to the embodiments of the present invention; and

FIGS. 5A-5B are illustrations of the association of a facet with an advertiser's web page.

### DETAILED DESCRIPTION OF THE INVENTION

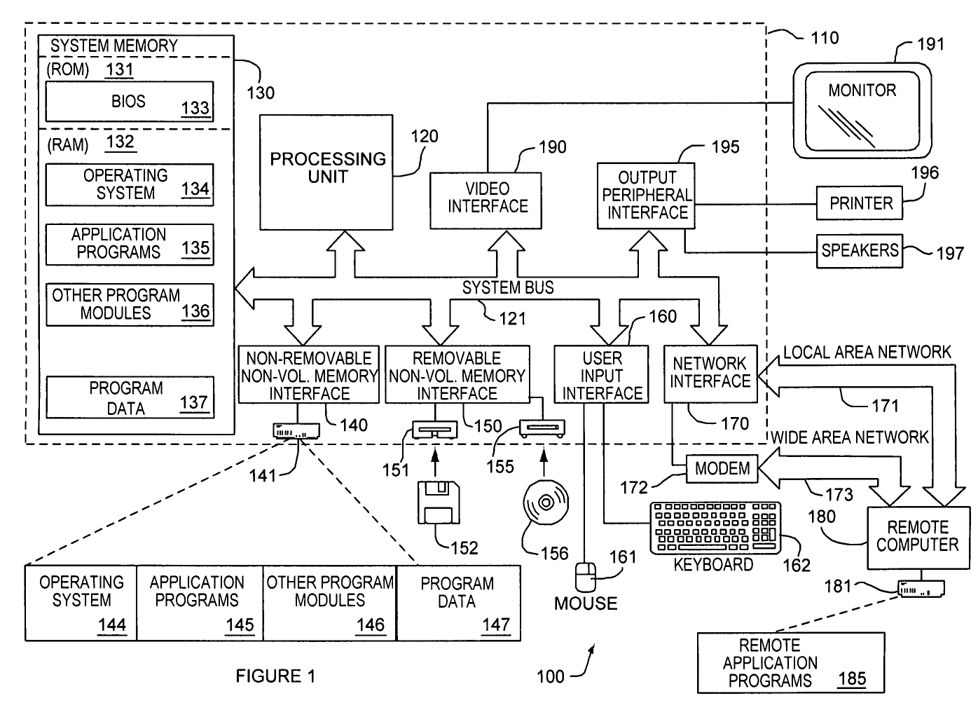

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Interconnect (PCI) bus also know as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable medial may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently begin operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drive and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different number here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user network interface 170, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

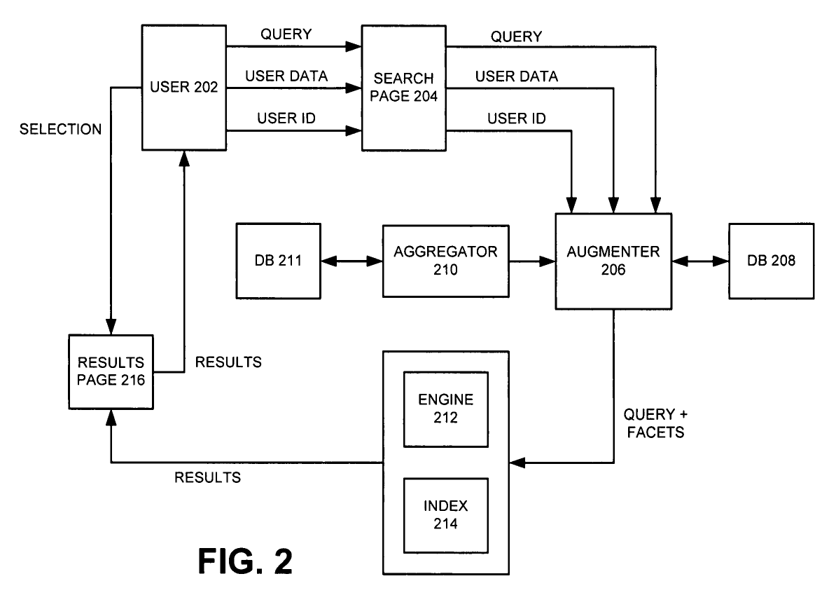

FIG. 2 is a flow diagram of a facet extraction system, according to the embodiments of the present invention. As illustrated in FIG. 2, user 202 submits a query to search page 204. Augmenter 206, which is in communication with database 208, receives the query from search page 204 and user data from user 202. Augmenter 206 also receives aggregate data from aggregator 210, which, in turn, communicates with database 211. Augmenter 206 augments the query with one or more facets and transmits the combination of query and facet(s) to search engine 212 and search index 214. Embodiments of the present invention are not limited to any particular number of facets. In an embodiment of the present invention, a facet is a global unique identifier that is associated with at least one attribute of a web page. However, embodiments of the present invention are not limited to any particular type of facet. For example, the facets may be file information associated with a local file on a system. In another example, a facet might be an identifier associated with an entire website or an identifier associated with a page in an intranet. In an embodiment, each facet is at least a unique numerical I.D. However, embodiments of the present invention are not limited to numerical I.D.s as any other format or combination of formats is possible, such as alphanumerical or a key and value pair. In an embodiment, the facets may be associated with web page information such as type of service provided, location, hours of availability, etc.; however, embodiments of the present invention are not limited to any particular facet information. Results page 216 receives results from search engine 212. To search engine 212, the facet is the same as any other search query. Search engine 212 is well-known in the art, and based on what it views as a multi-word query (the query plus facet), generates search results and presents them to user 202 via results page 216. A selection of one of the results by user 202 is then received by the results page 216.

In an embodiment, user 202 is a human being using a computer system. Embodiments of the present invention are not limited to any particular search engine technology. Google, MSN Search, and Yahoo! are three examples of possible search pages 204. In addition, the search page could lead to an intranet search, a search of a local computer's file system, or any other search technology. In an embodiment, the query is a text string that user 202 inputs into search page 204. However, embodiments of the present invention are not limited to text strings. For example, in an embodiment, other queries may be segments of sound samples, portions of images or other combinations of text, multimedia and other information which is capable of being represented by a computer. User data may be considered by augmenter 206 in determining the facets. In an embodiment, the user data comprises a physical location of user 202; however, embodiments of the present invention are not limited to any particular user data. For example, the user data may be an IP address, a user profile of user 202, information as to whether user 202 is presently using a stationary personal computer or a mobile device, etc. In an embodiment, the user data is transmitted from user 202 to augmenter 206 via search page 204 through the use of a cookie; however, embodiments of the present invention are not limited to cookies. For example, the user information may be received by augmenter 206 via a server-side solution such as a Universal Personal Information Store or a custom client-side data source solution. In that instance, a user ID is assigned when user 202 clicks on a link, and the user ID is stored along with the user information, for example, in database 208. When user 202 accesses search page 204, a cookie is created that contains the user ID. The cookie is forwarded to augmenter 206 by search page 204, and augmenter 206 accesses database 208 to retrieve the user information via the user ID. In an embodiment, the aggregate data consists of past user behavior associated with user 202 or user behavior for one or multiple other users; however, embodiments of the present invention are not limited to any particular aggregate data. For example, the aggregate data could be aggregate user behavior for other users in close physical proximity to the present user 202.

In an embodiment, augmenter 206 adds facets to queries where augmenter 206 determines that augmenting queries with facets would increase relevance of the search results. In an embodiment, augmenter 206 determines relationships between a query and prospective facets by examining aggregate click-through data. One embodiment is to calculate the conditional probabilities for individual facet-query pairs. When the probability that a user will click on a page with a given facet meets a certain threshold, a correlation between the query and the facet will be found to exist. Another embodiment builds on this mechanism by taking into account facets which have already been identified as relevant. These initial facets, in conjunction with query terms, then help identify still more facets resulting in a still more precise query representation. Groups of facets are considered together as clusters in order to determine search context. However, embodiments of the present invention are not limited to any particular method for determining relationships between a facet and a query, as other methods may be used to discover and prioritize query-facet correlation.

In an embodiment, augmenter 206 augments a query by adding facets which will restrict the set of results to those pages that contain those facets. These are called restricted queries as results pages must contain these facets. In another embodiment, augmenter 206 augments a query with facets which influence, positively or negatively, the relevance of candidate the result pages. These are called preferred queries. The prefer operator is a way of reordering the query results, and is a standard search operator. In an embodiment, when augmenter 206 is operating in preferred mode, the tag “Prefer:” is added to the query followed by the query terms. In an example, the query “pizza prefer:delivery” would only return results that contain the word “pizza,” but if a result also contains the word “delivery,” then it is given extra weight and will score higher in the results. In an embodiment, the weight of the prefer can be specified. For example, the query “pizza prefer:3.0:delivery” would cause the relevance score of each result containing the words “pizza” and “delivery” to be scaled by a factor of 3.0. As would be apparent to someone with skill in the art, any weighting system may be used, and the present invention is not limited to any particular system. However, embodiments of the present invention are not limited to any particular method for augmenting a query using facets.

Additionally, in an embodiment, augmenter 206 considers aggregated past user behavior to provide personalized search results to users. In an embodiment, aggregator 210 creates a record of user 202's interests by tracking the facets that are present on the search results that user 202 selects. In an embodiment, aggregator 210 will gather information about user 202's selection using a redirect procedure. Using a redirect, when user 202 selects a search result, the linked page will first be a local site where the facets associated with the link and user information are recorded. Once the facets have been recorded, user 202 will be automatically redirected to the desired web page. The entire procedure takes a very short amount of time, and often user 202 will not even notice. However, embodiments of the present invention are not limited to any particular mechanism for gathering such information.

Augmenter 206 considers an overall picture of user 202's preferences that emerges due to repeated facet appearance in user 202's chosen search results over time, as compiled by aggregator 210. For example, consider the query “pizza.” As discussed above, this query might suggest either a restaurant or a recipe. Without aggregate data for user 202, augmenter 206 might append two facets to the query for an anonymous user: ‘_restaurant,’ and ‘_recipe.’ Assuming user 202 has issued the same query many times and assuming that user 202 often selects restaurant web pages, the ‘_restaurant’ facet would be prominent. In an embodiment, augmenter 206 uses this information to include the ‘_restaurant’ facet or to drop the ‘_recipe’ facet. In another example, assume no facets are matched with a query. Where user 202 issued a query recently that resulted in facets, augmenter 206 could import those facets into the present query. Where the previous query was sufficiently recent, augmenter 206 might determine that the present query is about the same topic, justifying the importation of previous facets. Thus, augmenter 206 is able to personalize the query and facet information for a particular user 202. Embodiments of the present invention are not limited to consideration of user 202 preferences that may arise out of aggregated past user behavior. For example, in an embodiment augmenter 206 may add a ‘_location’ facet where augmenter 206 determines from the user data that user 202 is on a mobile device. Embodiments of the present invention are not limited to any particular number of facets with which to augment each query, as any number may be used. Further, in an embodiment, aggregator 210 compiles aggregate data on multiple users.

In an embodiment, search index 214 indexes potential search results with facets. For example, in the context of a web search engine, search index 214 would index web pages. If one example of a facet, which happened to be a numerical I.D., was intended to represent George W. Bush, the 43^{rd} President of the United States, search index 214 would add that facet, e.g., 76925, to all web pages containing a reference to George W. Bush. Therefore, web pages that contained text such as “George W. Bush,” “George W Bush,” “Dubya,” “G. W. Bush,” “G W Bush,” “43^{rd} President,” “current president,” etc., would be indexed with 76925 as a facet. Then, when search engine 212 received an augmented search result that included 76925 as one of the search terms, search engine 212 would return all web pages indexed as containing the 76925 facet relating to George W. Bush. This is clearly advantageous over the current search technology, because users are able to find pages that may only contain “dubya” when they searched for “George W. Bush” to retrieve information on the President. This is possible with the present invention because of the functions of search index 214 and augmenter 206. Search engine 212 may be any well-known search engine and does not even need to be made aware of the existence or use of facets.

In an embodiment, the query and facets are transmitted by augmenter 206 to search engine 212. In an embodiment, the query and facets are text strings that search engine 212 will recognize as search terms; however, embodiments of the present invention are not limited to any particular query and facet format. For example, the query and/or facet may include a character that represents an operator to search engine 212. Search engine 212 is well-known in the art. In an embodiment, search engine 212 runs a web search. However, embodiments of the present invention are not limited to web searching, as search engine 212 may run an intranet search, a search of a local computer's file system, or any other search. In the context of web searching, the results transmitted to results page 216 from search engine 212 are links to web pages; however, embodiments of the present invention are not limited to any particular type of results. For example, the results may be files on a local system, links on an intranet, etc. In an embodiment, the results presented by results page 216 to user 202 are displayed as a list of links to different websites; however embodiments of the present invention are not limited to any results presentation format. For example, the results may be displayed as a list of links to pages within a single website. In another example, the results may be presented in an audio format where the visual display is not the primary output device to user 202.

Also, it will be clear to someone of ordinary skill in the art that facets are not necessarily equivalent to additional search terms. In other words, the present invention does not merely augment user queries with additional search terms and feed the combined search terms to search engine 212. As discussed above, each facet is unique. Also as discussed above, search index 214 indexes potential search results with facets. Therefore, when search engine 212 searches for the query and facet combination, it is simply acting normally because it views the facet as just another search term and is able to search for the facet accordingly.

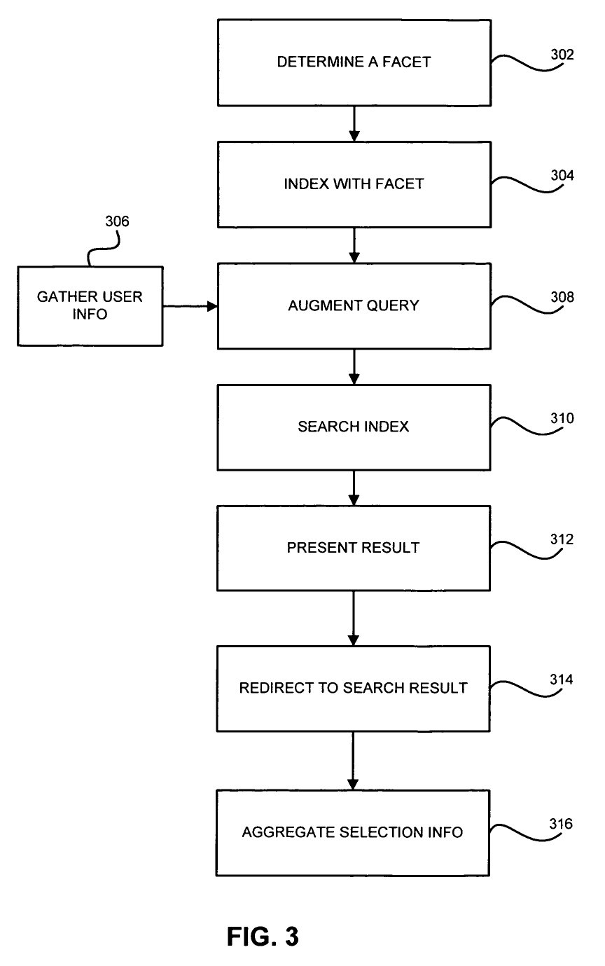

FIG. 3 is a flowchart illustrating facet extraction and use, according to the embodiments of the present invention. Specifically, FIG. 3 illustrates the use of facet extraction to augment search results. As illustrated in FIG. 3, a facet is determined (302). The determined facet is used to index potential search results, e.g., web pages (304). In an embodiment, a web page is indexed with any number of facets pertinent to the web page; however, embodiments of the present invention are not limited to any particular method of facet indexing or any number of facets per result. For example, the facets may be indexed to a web page according to the priority of each facet, creating a list of priority. In another example, facets may be associated with a local file. In an embodiment, user information is gathered (306) by determining an IP address of the user and gathering information from the IP address; however embodiments of the present invention are not limited to any specific method of gathering user information. For example, past information from other users regarding a particular query may be gathered without considering any information from the present user. A query is augmented with at least one facet as discussed above (308). An index is searched for the query and facet(s) (310) and the search results are presented to user as discussed above (312). In an embodiment, user is redirected to a local page (314) and the selection information is aggregated (316).

In an embodiment, trusted data sources such as yellow page business listings, musical artist listings, product databases, news stories, etc. can be used to determine facets. For example, a yellow page listing of businesses provides a categorized listing of businesses and their locations, from which yellow page type facets can be generated using simple string matching to business names. From the categorization information of each business, one or more facets can be generated for the business's corresponding web page. For businesses without a home page, a pseudo page can be generated that contains the information for the business to be placed into the index. The process for deciding relevant facets will likely be iterative. Trusted data sources provide a good starting point. For example, in an embodiment, phone numbers, addresses, and company names may be important facets for businesses. Individual names are important for entertainment, news, and white page searches. Categories for businesses and products are important in yellow page searches. The level of user interaction with a given page can also be assessed and a facet can be associated with the type of user interaction on a page. Embodiments of the present invention are not limited to any particular facet determining mechanism. For example, facets may be determined by web page operators submitting facet information for a web page.

In an embodiment, query augmenting acts autonomously from the searching technology. In effect, the searching technology recognizes the query augmented with facets as a traditional query. To achieve this level of autonomy, the augmenter appends facets onto the query in a text string format resembling a traditional query. This format allows the search engine functionality to recognize the augmented query as a traditional query by recognizing facets as search terms. Embodiments of the present invention are not limited to any particular search technology. For example, search technology might function in conjunction with the facet augmentation, in which case the level of autonomy between the two functions would be limited and the search technology might recognize facets as supplemental to the original query.

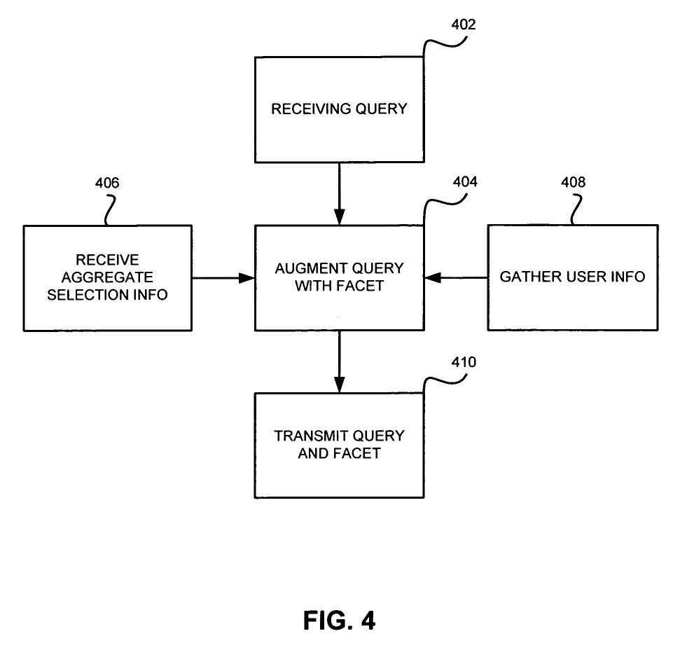

FIG. 4 is a flowchart illustrating query augmentation, according to the embodiments of the present invention. As illustrated in FIG. 4, a query is received (402) and is augmented with a facet (404). In an embodiment, aggregate selection information is received (406). In another embodiment, user information is gathered (408); however, embodiments of the present invention are not limited to augmentation using any particular information. For example, the query may be augmented with only portions of the information discussed above, or additional information may be received to facilitate effective augmenting. The query and the facet(s) are transmitted to a search engine (410).

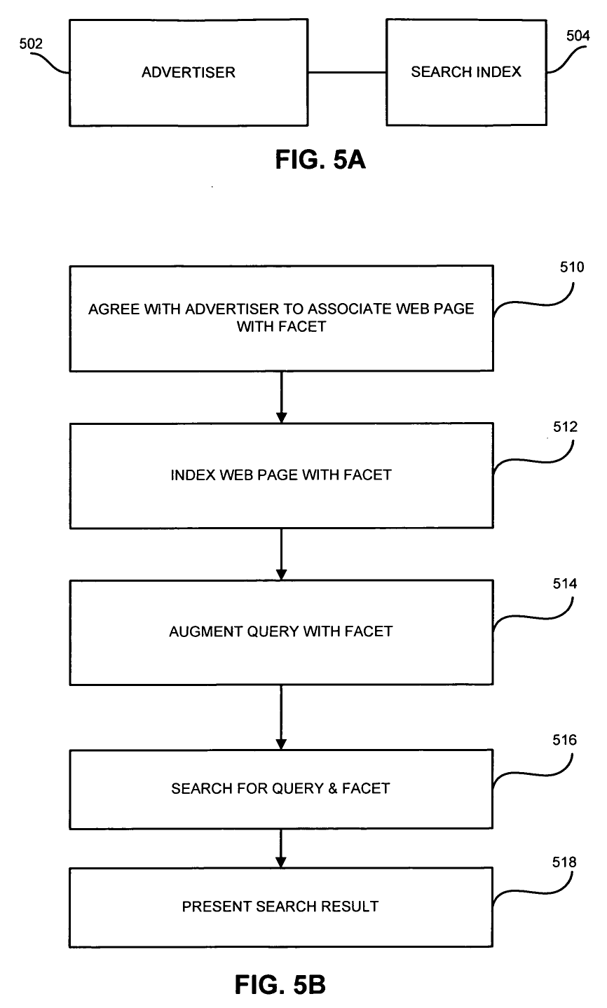

FIGS. 5A-5B are illustrations of the association of a facet with an advertiser's web page. FIG. 5A illustrates a relationship between an advertiser (502) and a search index (504). The advertiser is not limited to a traditional advertiser; rather, for the purposes of the present invention, an advertiser is defined as any entity that wants to increase access to information through the use of a facet. In an embodiment, the advertiser purchases an association with a particular facet, or set of facets, seeking to achieve a higher level of priority in the search index for searches implicating the facet(s). However, embodiments of the present invention are not limited to any particular advertiser-search index relationship, as other arrangements may be agreed upon. For example, the advertiser might not purchase a facet in the traditional sense where monetary value changes hands. Instead, the advertiser might enter some form of business relationship with the search index that does not necessitate a direct transfer of funds.

FIG 5B is a flowchart illustrating a method for associating a facet with an advertiser. An agreement with an advertiser to associate a web page with a facet is made (510). The web page is indexed with the facet (512). A query is augmented with the associated facet (514). The query containing the facet is searched for (516). A web page that was associated with the facet is presented as a search result (518). Embodiments of the present invention are not limited to any search and display mechanisms. For example, the user might be linked directly to a web page where a particular page is prioritized higher than any of the other search results.

Using the present invention, an advertiser can purchase one facet and associate its web page with a plurality of query terms related to the particular facet. It will be clear to someone of ordinary skill in the art that this is a beneficial arrangement. For example, if an advertiser is a pizza restaurant, it may choose to purchase the facet ‘_restaurant.’ By associating its web page with the ‘_restaurant’ facet, the advertiser's web page would appear as a priority result in any query augmented with that facet. A user query for “pizza,” “pizza restaurant,” “restaurant,” “pizza place,” “pie,” “delivery,” “piza,” “pisa,” “pitza,” etc. would be augmented with the ‘_restaurant’ facet where the augmentation is likely to increase the relevance of the results presented to the user. This method is clearly advantageous over the current search technology because it enables an advertiser to target users interested in its product without being forced to anticipate alternative or additional query terms used by potential consumers. The present invention makes this possible by augmenting queries with facets.

In an embodiment, the advertiser's web page will be presented at or near the top of a traditional results list, a position that is desirable to the advertiser. However, embodiments of the present invention are not limited to any particular presentation method. For example, a link to the advertiser's web page may be located in a banner above or to the side of a traditional list of search results. In another example, the user might be linked directly to the advertiser's web page where there are no other advertisers for a subject area.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The invention claimed is:

1. A method, comprising:
determining a facet from a web page to be indexed for searching;
indexing the web page with the facet in a search index;
augmenting a user's web search query with the facet;
searching the search index for the query and the facet; and
presenting to the user, as a search result, the indexed web page based on the query and the facet.

2. The method of claim 1, further comprising:
gathering user information.

3. The method of claim 2, further comprising:
redirecting the user to the search result via a second web page when the user selects the search result, wherein the user information is gathered via the redirection.

4. The method of claim 2, wherein the user information is gathered via a cookie.

5. The method of claim 2, further comprising:
determining an IP address of the user, wherein the user information is gathered from the IP address.

6. The method of claim 1, further comprising:
collecting selection information about a plurality of selections of search results by a plurality of users; and
aggregating the selection information, wherein the facet is determined based in part on the aggregated selection information.

7. The method of claim 1, wherein the facet is a global unique identifier that is associated with at least one attribute of the web page.

8. The method of claim 1, wherein the facet is indexed in the search index as a search term.

9. A method, comprising:
receiving a user's web search query;
augmenting the query with a facet; and
transmitting the query and the facet to a search engine.

10. The method of claim 9, wherein the facet is a global unique identifier that is associated with at least one attribute of a web page.

11. The method of claim 9, further comprising:
choosing the facet based on aggregate selection information about a plurality of selections of search results by a plurality of users.

12. The method of claim 9, further comprising:
choosing the facet based on user information.

13. The method of claim 12, further comprising:
gathering the user information.

14. The method of claim 13, wherein the user information is gathered via a redirection of the user to a search result via a second web page when the user selects the search result.

15. The method of claim 13, wherein the user information is gathered via a cookie.

16. The method of claim 13, further comprising:
determining an IP address of the user, wherein the user information is gathered from the IP address.

17. The method of claim 9, wherein the query and the facet are transmitted to the search engine as search terms.

18. A method, comprising:
agreeing with an advertiser to associate a web page with a facet; and
indexing the web page with the facet in a search index.

19. The method of claim 18, further comprising:
augmenting a user's web search query with the facet;
searching the search index for the query and the facet; and
presenting to the user, as a search result, the indexed web page based on the query and the facet, wherein the facet is indexed in the search index as a search term.

20. The method of claim 19, wherein the web page is presented to the user in a position that is desirable to the advertiser.
